(19) United States
(12) Patent Application Publication
(10) Pub. No.: US 2009/0018240 A1
(43) Pub. Date: Jan. 15, 2009

(54) Use of Water-Soluble or Water-Dispersible Polymers as Additives in Mineral Building Materials

(75) Inventors: Stefan Becker, Mannheim (DE); Ludwig Volkel, Limburgerhof (DE); Thomas Gotz, Leimersheim (DE); Bernd Meyer-roscher, Neustadt (DE); Markus Klumpe, Mannheim (DE); Wolfgang Hansch, Schwegenheim (DE); Arnold Burek, Ludwigshafen (DE); Stefanie Spilger, Schwetzingen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Akiengesellschaft, Ludwigshafen (DE)

(21) Appl. No.: 10/588,194

(22) PCT Filed: Feb. 16, 2005
(86) PCT No.: PCT/EP05/01536

§ 371 Date: Aug. 2, 2006

(30) Foreign Application Priority Data
Feb. 18, 2004 (DE) 10 2004 008 200.6

(51) Int. Cl. C04B 24/26; C08G 63/52

(52) U.S. Cl. 524/5; 528/306

(57) ABSTRACT

The present invention relates to the use of water-soluble or water-dispersible polymers as additives in mineral building materials. The novel polymers are obtainable by polymerizing alkoxylated derivatives of 3-allyloxy-1,2-propanediol with ethylenically unsaturated mono- or dicarboxylic acids or the anhydrides, esters or mixtures thereof and, if appropriate, with one or more further ethylenically unsaturated monomers C.

The present invention relates to water-soluble or water-dispersible polymers as additives in mineral building materials. The novel polymers are obtainable by polymerizing alkoxylated derivatives of 3-allyloxy-1,2-propanediol with ethylenically unsaturated mono- or dicarboxylic acids or the anhydrides, esters or mixtures thereof and, if appropriate, with one or more further ethylenically unsaturated monomers C.

Copolymers comprising alkoxylated derivatives of 3-allyloxy-1,2-propanediol and (meth)acrylic acid and, if appropriate, a further monomer copolymerizable therewith, and the use of such copolymers as dispersants for inorganic pigments, are described in JP 58154761.

U.S. Pat. No. 4,500,693 discloses copolymers comprising alkoxylated derivatives of 3-allyloxy-1,2-propanediol and (meth)acrylic acid, and methods for the preparation of such copolymers and the use thereof as dispersants for pigments and incrustation inhibitors.

JP 58147413 claims copolymers comprising alkoxylated derivatives of 3-allyloxy-1,2-propanediol and unsaturated dicarboxylic acids and methods for their preparation.

Additives for mineral building materials comprising alkoxylated derivatives of allyl alcohol and unsaturated mono- and dicarboxylic acid are described in U.S. Pat. No. 5,661,206.

Cement dispersants comprising copolymers which are obtainable by polymerizing at least one alkoxylated derivative of allyl alcohol, at least one ester of methacrylic acid or acrylic acid with a polyalkylene alcohol, at least one monomer selected from maleic acid and maleic anhydride and at least one monomer selected from acrylic acid, methacrylic acid and itaconic acid are described in WO 01/21542.

WO 01/21541 describes cement dispersants which are obtained by copolymerizing at least one alkoxylated derivative of allyl alcohol, at least one monomer selected from maleic acid and maleic anhydride and at least one monomer selected from acrylic acid, methacrylic acid and itaconic acid.

On the other hand, the use of copolymers which are polymerizing alkoxylated derivatives of 3-allyloxy-1,2-propanediol with ethylenically unsaturated carboxylic acids as an additive in mineral building materials has not been described to date.

Copolymer structures obtained by polymerizing at least one alkoxylated derivative of 3-allyloxy-1,2-propanediol, at least one unsaturated acid and at least one ester of acrylic acid or methacrylic acid with a polyalkylene oxide have likewise not been described to date in the prior art.

The additives known to date from the prior art are as a whole still in need of improvement for the uses according to the invention.

In particular, the plasticizing effect of the additives in mineral building materials at low water/binder ratios is as a rule still insufficient or is maintained only over a short time span. Although a higher dose of the plasticizer can partly remedy these deficiencies, this results in considerable decreases in the achievable mechanical strength or at least unacceptable retardations of the setting rates, in addition to the uneconomical nature of such a procedure.

It is an object of the present invention to provide additives, in particular for mineral building materials, which, with regard to their plasticizing effect, have advantages over the known additives for mineral building materials.

Surprisingly, we have found that water-soluble or water-dispersible polymers obtainable by polymerizing
a) at least one alkoxylated derivative of 3-allyloxy-1,2-propanediol (monomer A) and
b) at least one ethylenically unsaturated mono- or dicarboxylic acid or the anhydrides, esters or mixtures thereof (monomer B) and
c) if appropriate, one or more further ethylenically unsaturated monomers C
   have advantageous properties as additives in mineral building materials.

The present invention therefore relates to the use of such polymers in mineral building materials, and mineral building materials, in particular gypsum dispersants or cement dispersants, comprising the novel polymers, and processes for their preparation.

The present invention furthermore relates to polymers obtainable by polymerizing
a) at least one alkoxylated derivative of 3-allyloxy-1,2-propanediol (monomer A) and
b) at least one ethylenically unsaturated mono- or dicarboxylic acid or the anhydrides, esters or mixtures thereof (monomer B) and
c) if appropriate, one or more ethylenically unsaturated monomers C,
   the use thereof in mineral building materials, and mineral building materials, in particular gypsum dispersants or cement dispersants, comprising the novel polymers.

In a preferred embodiment, at least one compound of the formula I

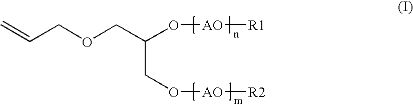

where
AO is C₁-C₁₂-alkylene oxide, styrene oxide or a mixture of two or more types thereof, it being possible for the two or more types to be linked either in random or in block form,
n and m, independently of one another, are each an integer from 1 to 300 and
R1 and R2, independently of one another, are each hydrogen, C₁-C₃₀-alkyl, C₅-C₈-cycloalkyl, C₆-C₂₀-aryl, C₁-C₃₀-alkanoyl, C₇-C₂₁-aroyl, sulfuric (mono)ester or phosphoric ester,
   is used as monomer A.

In an embodiment which is likewise preferred, at least one compound of the formula II

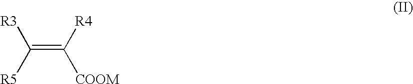

where
R3 and R4, independently of one another, may in each case be identical or different and are hydrogen or C₁-C₆-alkyl,
R5 is hydrogen, C₁-C₆-alkyl or a COOM group and
M is hydrogen, a monovalent or divalent metal ion, ammonium or an organic ammonium compound,
   is used as monomer B.

In a further embodiment which is likewise preferred, an ester of the formula III of (meth)acrylic acid with a polyalkylene oxide

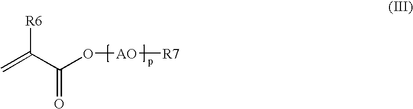

where
R6 is hydrogen or a methyl radical,
AO is C₁-C₁₂-alkylene oxide, styrene oxide or a mixture of two or more types thereof, it being possible for the two or more types to be linked either in random or in block form,
R7 is hydrogen, C₁-C₃₀-alkyl, C₅-C₈-cycloalkyl, C₆-C₂₀-aryl, C₁-C₃₀-alkanoyl or C₇-C₂₁-aroyl and
p is an integer from 1 to 300,
   is used as monomer C.

Mineral building materials are to be understood as meaning formulations which comprise, as substantial components, mineral binders, such as lime, gypsum and/or in particular cement, and sands, gravels, crushed rocks or other fillers, e.g. natural or synthetic fibers, serving as aggregates. The mineral building materials are as a rule converted into a ready-to-use formulation by mixing the mineral binders and the aggregates together with water, which ready-to-use formulation, when left to stand, becomes stone-hard in the course of time in the air or under water.

C₁-C₁₂-Alkylene oxides are understood as meaning, for example, ethylene oxide, propylene oxide, 1-butylene oxide, isomers of butylene oxide, higher alkylene oxides, such as dodecene oxide, styrene oxide and mixtures of the oxides in any desired sequence, the ethylene oxide content being at least 40%. Alkylene oxide is preferably ethylene oxide or a mixture of ethylene oxide and propylene oxide.

n and m, independently of one another, are each an integer from 1 to 300, preferably from 10 to 200, very particularly preferably from 20 to 100.

p is an integer from 1 to 300, preferably from 10 to 200, very particularly preferably from 20 to 200.

A C₁-C₃₀-alkyl radical is understood as meaning linear or branched saturated hydrocarbon chains of up to 30, preferably 1 to 10, carbon atoms, e.g. methyl, ethyl, n-propyl, isopropyl, n-butyl, tert-butyl, n-pentyl, neopentyl, n-hexyl, 2-ethylhexyl, n-octyl, 1-decyl, 1-dodecyl, etc., preferably methyl, ethyl, n-propyl and isopropyl, particularly preferably having one carbon atom (methyl).

A C₅-C₈-cycloalkyl radical is understood as meaning a cycloaliphatic radical of 5 to 8 carbon atoms selected from cyclopentyl, cyclohexyl, cycloheptyl and cyclooctyl, which may be optionally substituted by 1, 2, 3 or 4 C₁-C₄-alkyl groups.

C₆-C₂₀-Aryl is an aryl group which may have 6 to 20 carbon atoms, e.g. phenyl or ethylphenyl, or which is bonded via an alkylene unit, e.g. benzyl.

C₁-C₃₀-Alkanoyl is a radical which is derived from an aliphatic carboxylic acid and thus includes, in addition to formyl and acetyl, those alkyl radicals which are bonded via a carbonyl group.

C₇-C₂₁-Aroyl corresponds to C₇-C₂₁-arylcarbonyl and is an aryl radical which is bonded via a carbonyl group and is thus derived from derivatives of benzoic acid and of naphthoic acid.

A monovalent or divalent metal ion is understood as meaning a cation of the elements of the first and second main groups of the Periodic Table of the Elements, i.e. Li⁺, Na⁺, K⁺, Rb⁺, Cs⁺, Be²⁺, Mg²⁺, Ca²⁺, Sr²⁺ or Ba²⁺ and Ag⁺, Fe²⁺, Co²⁺, Ni²⁺, Cu²⁺, Zn²⁺, Cd²⁺, Sn²⁺, Pb²⁺ or Ce²⁺. The cations of the alkali metals and alkaline earth metals are preferably Li⁺, Na⁺, K⁺, Rb⁺, Cs⁺, Be²⁺, Mg²⁺, Ca²⁺, Sr²⁺ and Ba²⁺ and Zn²⁺. Li⁺, Na⁺, K⁺, Mg²⁺, Ca²⁺ and Zn²⁺ are particularly preferred.

An organic ammonium ion is a monovalent ion which forms as a result of protonation of a mono-, di- or trialkylamine or of a mono-, di- or trialkanolamine of 1-10 carbon atoms. Examples of mono-, di- and trialkylamines are methylamine, ethylamine, n-propylamine, isopropylamine, dimethylamine, diethylamine, di-n-propylamine, diisopropylamine, trimethylamine and triethylamine. Examples of mono-, di- and trialkanolamines are 2-aminoethanol, diethanolamine, triethanolamine and triisopropanolamine.

R1 is preferably hydrogen, methyl, ethyl, n-propyl, n-butyl and benzyl, formyl, acetyl or propionyl, particularly preferably hydrogen, methyl, acetyl and propionyl.

R2 is preferably hydrogen, methyl, ethyl, n-propyl, n-butyl and benzyl, formyl, acetyl or propionyl, particularly preferably hydrogen, methyl, acetyl and propionyl.

R3 and R4 are preferably hydrogen or methyl.

R5 is preferably hydrogen, methyl or a COOM group.

M is preferably hydrogen or a monovalent metal ion.

Preferably used monomers A are alkoxylated derivatives of 3-allyloxy-1,2-propanediol having altogether (i.e. n+m) 20-400 mol of alkylene oxide, which carry, as further radicals R1 and R2, in each case independently of one another, preferably hydrogen, methyl, acetyl or propionyl. Preferred alkylene oxides are ethylene oxide or propylene oxide, which in each case may be present alone or as mixtures in random or block sequence in the monomer A.

Preferably used monomers B are monoethylenically unsaturated C₃-C₆-monocarboxylic acids, such as acrylic acid, methacrylic acid, crotonic acid, isocrotonic acid or 2-ethylpropenoic acid or the esters thereof, or ethylenically unsaturated C₄-C₆-dicarboxylic acids or the esters or anhydrides thereof, such as maleic acid, maleic anhydride, fumaric acid, itaconic acid or the sodium, potassium or ammonium salts thereof.

In addition to the monomers A and B, the polymer can, if appropriate, also comprise monomers C. Monomers C which may be used are, for example, C₁-C₈-alkyl esters or C₁-C₄-hydroxyalkyl esters of acrylic acid, methacrylic acid or maleic acid or esters of C₁-C₁₈-alcohols, alkoxylated with from 2 to 50 mol of ethylene oxide, propylene oxide, butylene oxide or mixtures thereof, with acrylic acid, methacrylic acid or maleic acid, e.g. hydroxyethyl acrylate, hydroxyethyl methacrylate, hydroxypropyl(meth)acrylate or butyl(meth)acrylate.

Preferably used monomers C are esters of acrylic or methacrylic acid with a polyalkylene oxide 10-200 alkylene oxide units. Esters of polyalkylene oxide monoalkyl ethers having a terminal methyl group are particularly preferred. Particularly preferred alkylene oxides are ethylene oxide or propylene oxide, which may be present alone or in random or block sequence in the monomer C.

Preferred polymers contain 10-70, preferably 30-70, mol % of monomer A, 1-70, preferably 5-50, particularly preferably 10-50, mol % of monomer B and 0-90, preferably 0-50, mol % of monomer C.

The preparation of the alkylene oxides can be effected, for example, by alkoxylation of 3-allyloxypropanediol, all catalysts known from the prior art of the polymerization of alkylene oxides and compatible with allyl ethers being suitable. An overview of some catalysts is given, for example, in F. E. Bailey, Jr, J. V. Koleske, Alkylene Oxides and their Polymers, NY and Basel 1991, page 35 et seq. Basic catalysts, such as NaOH, KOH, CsOH, KOtBu, NaOMe or mixtures of the bases with crown ethers, are particularly preferably used.

The alkoxylation can also be effected stepwise.

The adduct of alkylene oxides and 3-allyloxy-1,2-propanediol can be further functionalized. For example, the OH groups can be reacted with alkylating agents to give ethers or reacted with aliphatic or aromatic carboxylic acids or the halides or anhydrides thereof to give esters. The OH groups can also be converted into sulfates, sulfonates, phosphates or phosphonates, so that anionic terminal groups result.

The polymers can be carried out by conventional mass polymerization, solution polymerization and, in the case of poor solubility of the monomers, also emulsion, dispersion or suspension polymerization processes. It is also possible, in the case of sufficiently poor solubility of the polymer in the reaction mixture, to carry out the polymerization as a precipitation polymerization.

Said polymerization processes are preferably carried out in the absence of oxygen, preferably in a nitrogen stream. For all polymerization methods, the conventional apparatuses are used, for example stirred kettles, stirred kettle cascades, autoclaves, tubular reactors and kneaders. The solution and emulsion polymerization methods are preferred. If the preparation of the novel polymers is carried out by free radical, aqueous emulsion polymerization, it is advisable to add surfactants or protective colloids to the reaction medium. A list of suitable emulsifiers and protective colloids is to be found, for example, in Houben Weyl, Methoden der organischen Chemie, Volume XIV/1 Makromolekulare Stoffe, Georg Thieme Verlag, Stuttgart 1961, page 411 et seq.

The polymerization can be carried out in solvents or diluents, e.g. benzene, toluene, o-xylene, p-xylene, cumene, chlorobenzene, ethylbenzene, industrial mixtures of alkylaromatics, cyclohexane, industrial mixtures of aliphatics, acetone, cyclohexanone, tetrahydrofuran, dioxane, glycols and glycol derivatives, polyalkylene glycols and derivatives thereof, diethyl ether, tert-butyl methyl ether, tehrahydrofuran, methyl acetate, isopropanol, ethanol, water or mixtures, e.g. isopropanol/water mixtures. Water, if appropriate with amounts of up to 60% by weight of alcohols, glycols or polyalkylene glycols, is preferably used as solvent or diluent. Water is particularly preferably used.

The polymerization can be carried out at from 20 to 300° C., preferably from 20 to 150° C., particularly preferably 60-120° C. Depending on the choice of the polymerization conditions, weight average molecular weights (M_{w}) of, for example, from 1 000 to 100 000, preferably 5 000-50 000, can be established. M_{w} is determined by gel permeation chromatography.

The polymerization is preferably carried out in the presence of compounds forming free radicals. Up to 30, preferably from 0.05 to 15, particularly preferably from 0.2 to 8, % by weight, based on the monomers used in the polymerization, of these compounds are required. In the case of multicomponent initiator systems (e.g. redox initiator systems), the above weight data are based on the sum of the components.

Suitable polymerization initiators are, for example, peroxides, hydroperoxides, peroxodisulfates, percarbonates, peroxyesters, hydrogen peroxide and azo compounds. Examples of initiators, which may be water-soluble or water-insoluble, are hydrogen peroxide, dibenzoyl peroxide, dicyclohexyl peroxodicarbonate, dilauroyl peroxide, methyl ethyl ketone peroxide, di-tert-butyl hydroperoxide, acetylacetone peroxide, tert-butyl hydroperoxide, cumyl hydroperoxide, tert-butyl perneodecanoate, tert-amyl perpivalate, tert-butyl perpivalate, tert-butyl perbenzoate, lithium, sodium, potassium and ammonium peroxodisulfate and azobisisobutyronitrile.

The initiators can be used alone or as a mixture with one another, for example mixtures of hydrogen peroxide and sodium peroxodisulfate. For the polymerization in an aqueous medium, water-soluble initiators are preferably used.

The known redox initiator systems can also be used as polymerization initiators. Such redox initiator systems comprise at least one peroxide-containing compound in combination with a redox coinitiator, for example sulfur compounds having a reducing effect, e.g. bisulfites, sulfites, thiosulfates, dithionites and tetrathionates of alkali metals and ammonium compounds. Thus, combinations of peroxodisulfates with alkali metal or ammonium hydrogen sulfites may be used, e.g. ammonium peroxodisulfate and ammonium disulfite. The ratio of the peroxide-containing compound to the redox coinitiator is from 30:1 to 0.05:1.

In combination with the initiators or the redox initiator systems, it is additionally possible to use transition metal catalysts, for example salts of iron, cobalt, nickel, copper, vanadium and manganese. Suitable salts are, for example, iron(II) sulfate, cobalt(II) chloride, nickel(II) sulfate or copper(I) chloride. The transition metal salt having a reducing effect is used in a concentration of from 0.1 to 1 000 ppm, based on the monomers. Thus, combinations of hydrogen peroxide with iron(II) salts may be used, for example from 0.5 to 30% of hydrogen peroxide and from 0.1 to 500 ppm of Mohr's salt.

In the polymerization in organic solvents, too, redox coinitiators and/or transition metal catalysts, e.g. benzoin, dimethylaniline, ascorbic acid or complexes of heavy metals, such as copper, cobalt, iron, manganese, nickel and chromium, which are soluble in organic solvents, can be used in combination with the abovementioned initiators. The conventionally used amounts of redox coinitiators or transition metal catalysts are from about 0.1 to 1 000 ppm, based on the amounts of monomers used.

In order to control the average molecular weight of the polymers, it is often expedient to carry out the copolymerization in the presence of regulators. Conventional regulators, for example organic SH-containing compounds, such as 2-mercaptoethanol, 2-mercaptopropanol, 3-mercaptopropionic acid, cysteine or acetylcysteine, and also sodium hypophosphite or sodium hydrogen sulfite, may be used for this purpose. The polymerization regulators are generally used in amounts of from 0.1 to 10% by weight, based on the monomers. The average molecular weight can also be influenced by the choice of the suitable solvent. Thus, the polymerization in the presence of diluents having benzylic H atoms leads to a reduction in the average molecular weight through chain transfer.

In order to increase the molecular weight of the polymers, it may be expedient to carry out the copolymerization in the presence of small amounts of crosslinking agents. For this purpose, conventional crosslinking agents, such as bis(acrylates) of diols, such as ethylene glycol, diethylene glycol bisacrylate, triethylene glycol or polyethylene glycol, may be used in an amount of 0.01-5%, based on the monomers.

If the polymer is obtained by the process of solution polymerization in water, it is usually not necessary to separate off the solvent. If it is nevertheless desired to isolate the polymer, for example, spray-drying can be carried out.

If the polymer is prepared by the method of solution, precipitation or suspension polymerization in a steam-volatile solvent or solvent mixture, the solvent can be separated off by passing in steam, in order thus to obtain an aqueous solution or dispersion. The polymer can also be separated from the organic diluent by a drying process.

Preferably, the polymers are present in the form of an aqueous solution having solids contents of, preferably, from 10 to 80, in particular from 30 to 65, % by weight. The K values of the polymers are preferably in the range of 20-50.

The novel polymers are very useful as additives for cement mixes, such as concrete or mortar. Cement is to be understood as meaning, for example, Portland cement, alumina cement or mixed cement, such as pozzolana cement, slag cement or other types. Portland cement is preferred. The copolymers are used in an amount of from 0.01 to 10, preferably from 0.05 to 3, % by weight, based on the total weight of the cement.

The polymers can be added in solid form, which is obtainable by drying, for example by spray-drying of polymer solutions or dispersions as obtained in the polymerization, to the ready-to-use formulation of the mineral building material. It is also conceivable to formulate the copolymers with the mineral binder and to prepare the ready-to-use formulations of the mineral building material therefrom. The copolymer is preferably used in liquid, i.e. dissolved, emulsified or suspended, form, for example in the form of the polymer solution, in the formulation of the mineral building material.

For use in concrete or mortar, it may be advantageous to employ polymers which are converted into a water-soluble and hence effective form, e.g. carboxylic acid or carboxylic anhydride structures, only in the presence of the alkaline concrete or mortar. The slow release of the effective polymer results in a long-lasting activity.

The novel polymers can also be used in combination with the known concrete fluidizers and/or concrete plasticizers based on naphthalene-formaldehyde condensate sulfonate, melamine-formaldehyde condensate sulfonate, phenolsulfonic acid-formaldehyde condensate, lignin sulfonates and gluconates. Furthermore, they can be used together with celluloses, e.g. alkyl- or hydroxyalkylcelluloses, starches or starch derivatives. They can also be used in combination with high molecular weight polyethylene oxides (Mw 100 000-8 000 000).

Additives such as air pore formers, expansion agents, water repellents, setting retardants, setting accelerators, antifreezes, sealing compounds, pigments, corrosion inhibitors, flow agents, grouting assistants, stabilizers or hollow microspheres, can also be admixed. Such additives are described, for example, in EN 934.

In principle, the novel polymers can also be used together with film-forming polymers. These are to be understood as meaning polymers whose glass transition temperature is ≦65° C., preferably ≦50° C., particularly preferably ≦25° C., very particularly preferably ≦0° C. On the basis of the relationship stated by Fox (T. G. Fox, Bull. Am. Phys. Soc. (Ser. II) 1 (1956), 123, between glass transition temperature of homopolymers and the glass transition temperature of copolymers, the person skilled in the art is able to select suitable polymers.

It is furthermore often advantageous if the novel polymers are used together with antifoams. This prevents too much air from being introduced in the form of air pores into the concrete during formulation of the ready-to-use mineral building materials, which pores would reduce the strength of the set mineral building material. Suitable antifoams include in particular antifoams based on polyalkylene oxide, trialkyl phosphates, such as tributyl phosphate, and silicone-based antifoams. The ethoxylation products and the propoxylation products of alcohols of 10 to 20 carbon atoms are also suitable. The diesters of alkylene glycols or polyalkylene glycols and further conventional antifoams are also suitable. Such antifoams are usually used in amounts of from 0.05 to 10, preferably from 0.5 to 5, % by weight, based on the polymers.

The antifoams can be combined with the polymer in various ways. If the polymer is present, for example, in the form of an aqueous solution, the antifoam can be added in solid or dissolved form to the solution. If the antifoam is not soluble in the aqueous polymer solution, emulsifiers or protective colloids can be added in order to stabilize it.

If the novel polymer is present in the form of a solid, as is obtained, for example, from spray-drying or fluidized-bed spray granulation, the antifoam can be admixed as a solid or compounded together with the polymer in the spray-drying process or spray granulation process.

The examples which follow illustrate the invention without restricting it:

### EXAMPLES

### I. Analysis

### Determination of the Average Molecular Weight

The weight average molecular weight was determined by gel permeation chromatography (=GPC) using aqueous eluents.

The GPC was carried out using an apparatus combination from Agilent (series 1100).

This includes:

| | |
|---|---|
| Gasser | Model G 1322 A |
| Isocratic pump | Model G 1310 A |
| Autosampler | Model G 1313 A |
| Column oven | Model G 1316 A |
| Control module | Model G 1323 B |
| Differential refractometer | Model G 1362 A |

The eluent used in the case of polymers dissolved in water is 0.08 mol/l TRIS buffer (pH=7.0) in distilled water+0.15 mol/l chloride ions from NaCl and HCl.

The separation took place in a separation column combination. Column No. 787 and 788 (8×30 mm each) from PSS with separation material GRAL BIO linear are used.

The flow rate was 0.8 ml/min at a column temperature of 23° C.

The calibration is effected using polyethylene oxide standards from PPS, having molecular weights M of 194-1 700 000 [mol/g].

### Determination of the K Value

The K values of the aqueous sodium salt solutions of the copolymers were determined according to H. Fikentscher, Cellulose-Chemie, 13 (1932), 58-64 and 71-74 in aqueous solution at a pH of 7, a temperature of 25° C. and a polymer concentration of the sodium salt of the copolymer of 1% by weight.

### Determination of the Solids Content

The solids content is determined using the electronic moisture analyzer IR30 from Sartorius. For this purpose, an exactly defined amount of sample (about 0.5-1 g) is weighed into a small aluminum dish provided with a filter for the IR dryer from Sartorius (sample weight). Drying is then effected in the automatic measuring mode at 90° C. to constant weight, and the mass of the sample is determined again. The percentage solids content (SC) is calculated as follows:

SC=Final weight×100/sample weight [% by weight]

### II. Synthesis

### Alkoxylation

### Example A

### 3-Allyloxy-1,2-propanediol+16 EO

925 g (6.99 mol) of 3-allyloxypropanediol and 19.2 g of 45% strength aqueous potassium hydroxide solution were initially taken in a 20 l steel reactor having jacket cooling, oxide metering and an internal thermometer. For providing an inert atmosphere, the reactor was evacuated three times at 25° C. and subsequently a pressure of 14.1 bar was established each time with nitrogen. Thereafter, the pressure was let down to 1 bar and heating to an internal temperature of 100° C. was effected. The reactor was evacuated to <15 mbar for 150 minutes for removing water from the initially taken mixture. Thereafter, the nitrogen pressure in the reactor was brought to 0.6 bar and the temperature was increased to 120° C. 4 933 g (111.98 mol) of ethylene oxide were then metered in the course of 170 minutes so that the pressure was kept at from 1.3 to 4.3 bar and the internal temperature was kept at from 120 to 130° C. After the end of the addition, the reactor content was cooled to 80° C. and 5 810 g of product were discharged.

### Example B

### 3-Allyloxy-1,2-propanediol+40 EO

5 700 g of the product from example 1 (3-allyloxypropanediol+16 EO) were initially taken in the same reactor as described in example 1. For providing an inert atmosphere, evacuation was effected three times at 25° C. and subsequently a pressure of 13.6 bar was established each time with nitrogen.

The pressure was then let down to 1 bar and heating to an internal temperature of 100° C. was effected. The reactor was evacuated to <15 mbar for 60 minutes for removing water from the initially taken mixture. Thereafter, the nitrogen pressure in the reactor was brought to 0.7 bar and the internal temperature was increased to 120° C. 7 200 g (163.44 mol) of ethylene oxide were then metered in the course of 240 minutes so that the pressure was kept at from 1.3 to 3.7 bar and the internal temperature was kept at from 120 to 131° C. After the end of the addition, the reactor content was cooled to 80° C. and 12 833 g of product were discharged. The product had an OH number of 60.2 mg KOH/g.

### Polymerization

### Example 1

150 g of 3-allyloxy-1,2-propanediol+40 EO, dissolved in 269.92 g of water, and 7.6 mg of iron(II) sulfate heptahydrate were initially taken in a 1 l glass reactor having an anchor stirrer, thermometer, nitrogen inlet tube, reflux condenser and dropping funnel and were neutralized to pH 7 with 2.5 g of 10% strength acetic acid. For providing an inert atmosphere, nitrogen was passed into the reactor, and the mixture was then heated to an internal temperature of 100° C. 4.1 g of 10% strength hydrogen peroxide solution were added under reflux. After a waiting time of 5 minutes, the following feeds were metered in:
a) 30.44 g of acrylic acid, dissolved in 49.56 g of water, were metered in 8.5 hours, 27 g of the metered amount being added in the first hour, a further 27 g in the next 2 hours, 13 g in the following 2 hours and the remainder of the feed in 3.5 hours.
b) Beginning at the same time as feed a), 36.91 g of a 10% strength hydrogen peroxide solution were metered in continuously in 9 hours.
c) Two hours after the beginning of feeds a) and b), 23.04 g of a 5% strength aqueous mercaptopropionic acid solution were metered in continuously in the course of 7 hours.

After the end of said feeds, polymerization was continued for a further hour at 100° C. in order to complete the polymerization. Thereafter, the reactor content was cooled to 20° C. and neutralized with 50% strength sodium hydroxide solution.

### Example 2

200 g of 3-allyloxy-1,2-propanediol+40 EO, dissolved in 83.06 g of water, and 7.6 mg of iron(II) sulfate heptahydrate were initially taken in a 1 l glass reactor having an anchor stirrer, thermometer, nitrogen inlet tube, reflux condenser and dropping funnel and were neutralized to pH 7 with 3.45 g of 10% strength acetic acid. For providing an inert atmosphere, nitrogen was passed into the reactor, and the mixture was then heated an internal temperature of 100° C. 4.1 g of 10% strength hydrogen peroxide solution were added under reflux. After a waiting time of 5 minutes, the following feeds were metered in:
a) 30.41 g of acrylic acid were metered in continuously in 10 hours.
b) Beginning at the same time as feed a), 36.92 g of a 10% strength hydrogen peroxide solution were metered in continuously in 10.5 hours.

After the end of said feeds, polymerization was continued for a further hour at 100° C. in order to complete the polymerization. Thereafter, the reactor content was cooled to 20° C. and neutralized with 50% strength sodium hydroxide solution.

### Example 3

119.96 of 3-allyloxy-1,2-propanediol+40 EO, dissolved in 236.82 g of water, and 9.5 mg of iron(II) sulfate heptahydrate were initially taken in a 1 l glass reactor having an anchor stirrer, thermometer, nitrogen inlet tube, reflux condenser and dropping funnel and were neutralized to pH 7 with 1.43 g of 10% strength acetic acid. For providing an inert atmosphere, nitrogen was passed into the reactor, and the mixture was then heated to an internal temperature of 100° C. 5.13 g of 10% strength hydrogen peroxide solution were added under reflux. After a waiting time of 5 minutes, the following feeds were metered in:
a) 36.51 g of acrylic acid, dissolved in 263.49 g of 50% strength aqueous methylpolyethylene glycol methacrylate solution (M=2 080 g/mol; obtained from Aldrich) were added dropwise in two equal portions, the first in the course of 2 hours and the second in the course of 4 hours.
b) Beginning at the same time as feed a), 46.17 g of a 10% strength hydrogen peroxide solution were metered in continuously in 6.25 hours.
c) Two hours after the beginning of feeds a) and b), 28.82 g of a 10% strength aqueous mercaptopropionic acid solution were metered in continuously in the course of 4.25 hours.

After the end of said feeds, polymerization was continued for a further hour at 100° C. in order to complete the polymerization. Thereafter, the reactor content was cooled to 20° C. and neutralized with 50% strength sodium hydroxide solution.

### Example 4

94.94 g of 3-allyloxy-1,2-propanediol+40 EO, dissolved in 121.02 g of water, were initially taken in a 1 l glass reactor having an anchor stirrer, thermometer, nitrogen inlet tube, reflux condenser and dropping funnel. For providing an inert atmosphere, nitrogen was passed into the reactor, and the mixture was then heated an internal temperature of 100° C. 2.71 g of 10% strength sodium peroxodisulfate solution were added under reflux. After a waiting time of 5 minutes, the following feeds were metered in:
a) 17.70 g of acrylic acid, 13.19 g of methacrylic acid, 54.58 g of methylpolyethylene glycol methacrylate (M=1 068 g/mol) and 6.31 g of sodium hypophosphite, dissolved in 128.21 g of water, were metered in two equal portions, the first in 2 hours and the second in 4 hours.
b) Beginning at the same time as feed a), 24.39 g of a 10% strength aqueous sodium peroxodisulfate solution were metered in continuously in 6.25 hours.

After the end of said feeds, polymerization was continued for a further hour at 100° C. in order to complete the polymerization. Thereafter, the reactor content was cooled to 20° C. and neutralized with 50% strength sodium hydroxide solution.

### Comparative Example 1

150 g of allyl alcohol+40 EO, dissolved in 130.26 g of water, and 5.7 mg of iron(II) sulfate heptahydrate were initially taken in a 1 l glass reactor having an anchor stirrer, thermometer, nitrogen inlet tube, reflux condenser and dropping funnel. For providing an inert atmosphere, nitrogen was passed into the reactor, and the mixture was then heated to an internal temperature of 100° C. 3.09 g of 10% strength hydrogen peroxide solution were added under reflux. After a waiting time of 5 minutes, the following feeds were metered in:
a) 23.75 g of acrylic acid, dissolved in 96.25 g of water, were metered in 8 hours, 40 g of the metered amount being added in the first hour, a further 20 g in the next 2 hours, and the remainder of the feed in 3 hours.
b) Beginning at the same time as feed a), 27.84 g of a 10% strength hydrogen peroxide solution were metered in continuously in 8.5 hours.
c) Two hours after the beginning of feeds a) and b), 17.38 g of a 5% strength aqueous mercaptopropionic acid solution were metered in continuously in the course of 6.5 hours.

After the end of said feeds, polymerization was continued for a further hour at 100° C. in order to complete the polymerization. Thereafter, the reactor content was cooled to 20° C. and neutralized with 50% strength sodium hydroxide solution.

### Comparative Example 2

130 g of allyl alcohol+40 EO, dissolved in 50.00 g of water, and 5 mg of iron(II) sulfate heptahydrate were initially taken in a 1 l glass reactor having an anchor stirrer, thermometer, nitrogen inlet tube, reflux condenser and dropping funnel. For providing an inert atmosphere, nitrogen was passed into the reactor, and the mixture was then heated to an internal temperature of 100° C. 3.00 g of 10% strength hydrogen peroxide solution were added under reflux. After a waiting time of 5 minutes, the following feeds were metered in:
a) 21.01 g of acrylic acid were metered in 10 hours.
b) Beginning at the same time as feed a), 27.00 g of a 10% strength hydrogen peroxide solution were metered in continuously in 10.5 hours.

After the end of said feeds, polymerization was continued for a further hour at 100° C. in order to complete the polymerization. Thereafter, the reactor content was cooled to 20° C. and neutralized with 50% strength sodium hydroxide solution.

### Comparative Example 3

122.00 of allyl alcohol+40 EO, dissolved in 205.05 g of water, and 9.9 mg of iron(II) sulfate heptahydrate were initially taken in a 1 l glass reactor having an anchor stirrer, thermometer, nitrogen inlet tube, reflux condenser and dropping funnel. For providing an inert atmosphere, nitrogen was passed into the reactor, and the mixture was then heated to an internal temperature of 100° C. 6.00 g of 10% strength hydrogen peroxide solution were added under reflux. After a waiting time of 5 minutes, the following feeds were metered in:
a) 38.6 g of acrylic acid, dissolved in 278.8 g of 50% strength aqueous methylpolyethylene glycol methacrylate solution (M=2 080 g/mol; obtained from Aldrich) were added dropwise in two equal portions, the first in 2 hours and the second in 4 hours.
b) Beginning at the same time as feed a), 54.00 g of a 10% strength hydrogen peroxide solution were metered in continuously in 6.25 hours.
c) Two hours after the beginning of feeds a) and b), 45.00 g of a 10% strength aqueous mercaptopropionic acid solution were metered in continuously in the course of 4.25 hours.

After the end of said feeds, polymerization was continued for a further hour at 100° C. in order to complete the polymerization. Thereafter, the reactor content was cooled to 20° C. and neutralized with 50% strength sodium hydroxide solution.

### Testing

Test method for concrete fluidizers based on EN 196 or DIN 18555 Part 2:

Apparatuses:
Mixer type 203 (from Testing Bluhm und Feuerhard GmbH)
Stopwatch
Laboratory balance (accuracy+−1 g)
Flow table d=300 mm (from Testing Bluhm und Feuerhard GmbH)
Slump cone
Dropping funnel with tube connection
Spoon
Vibrating table type 2.0233 (from Testing Bluhm und Feuerhard GmbH)

### Starting Materials:

1 500 g of standard sand CEN I-III
500 g of Heidelberger cement CEM I 32.5 R
225 g of water (comprising the polymeric additive)
   0.1-0.3% of a suitable antifoam is added one day before the test to the polymer solution to be tested.

### Carrying Out the Test

### a) Preparation of the Mortar

The total amount of the dry mix (cement+sand) is homogeneously mixed for one minute using the type 203 mixer.

The water, comprising the polymer to be tested and an antifoam, is then metered in continuously over a period of 30 seconds by means of the dropping funnel. After stirring for 3 minutes, the preparation of the mortar is complete.

The first measurement of the slump is then carried out.

### Water or Water/Fluidizer Mixture

b) Flow table rest according to DIN 18555 Part 2

For determining the slump, the slump cone is placed centrally on the glass plate of the flow table, the mortar is introduced in two layers and each layer is compacted by pressing with the spoon. During the filling, the slump cone is pressed onto the glass plate with a hand. The projecting mortar is scraped off and the free surface of the flow table is cleaned. The slump cone is then slowly drawn perpendicularly upward and the mortar is spread on the glass plate by means of 15 vertical impacts.

The diameter of the slumped mortar is then measured in two directions at right angles to one another. The result is stated as the arithmetic mean in cm.

The determination is carried out after 5, 30, 60 and 90 minutes. Before each measurement, the mortar is briefly stirred up.

| | | | | Mn | Mw | | | | | |
|---|---|---|---|---|---|---|---|---|---|---|
| | Solid | | K value | Number | Weight | Fluidizer | Slump | | | |
| | [%] | pH | [1% in H₂O] | average | average | Metering | 5 min | 30 min | 60 min | 90 min |
| Example 1 | 37.7 | 6.8 | 29.1 | 4 100 | 19 500 | 0.20% | 17.1 | 16.9 | 15.4 | 14.5 |
| Example 2 | 62.9 | 6.5 | 28.7 | 4 700 | 32 400 | 0.20% | 17.4 | 16.6 | 15.6 | 14.7 |
| Example 3 | 39.0 | 6.8 | 38.7 | 7 800 | 60 000 | 0.20% | 16.7 | 15.7 | 14.7 | 13.3 |
| Example 4 | 39.3 | 7.0 | 22.3 | 4 500 | 14 200 | 0.20% | 18.2 | 17.0 | 16.2 | 15.8 |
| Comparative | 39.3 | 6.7 | 33.5 | 4 500 | 28 500 | 0.20% | 16.8 | 15.0 | 14.0 | 13.2 |
| example 1 | | | | | | | | | | |
| Comparative | 61.6 | 6.8 | 34.9 | 8 100 | 29 300 | 0.20% | 17.7 | 16 | 14.7 | 14 |
| example 2 | | | | | | | | | | |
| Comparative | 39.4 | 6.7 | 39.3 | 6 400 | 64 000 | 0.20% | 15.4 | 14.2 | 12.7 | — |
| example 3 | | | | | | | | | | |

1. A mineral building material composition comprising a mineral building material and a water-soluble or water-dispersible polymer, obtained by polymerizing
a) at least one alkoxylated derivative of 3-allyloxy-1,2-propanediol (monomer A) and
b) at least one ethylenically unsaturated mono- or dicarboxylic acid or the anhydrides, esters or mixtures thereof (monomer B) and
c) if appropriate, one or more further ethylenically unsaturated monomers C.

2. The mineral building material composition according to claim 1, wherein at least one compound of the formula I 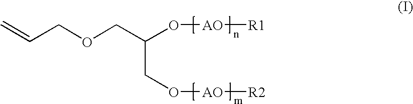
where
AO is C₁-C₁₂-alkylene oxide, styrene oxide or a mixture of two or more types thereof, it being possible for the two or more types to be linked either in random or in block form,
n and m, independently of one another, are each an integer from 1 to 300 and
R1 and R2, independently of one another, are each hydrogen, C₁-C₃₀-alkyl, C₅-C₈-cycloalkyl, C₆-C₂₀-aryl, C₁-C₃₀-alkanoyl, C₇-C₂₁-aroyl, sulfuric (mono)ester or phosphoric ester,
is used as monomer A.

3. The mineral building material composition according to claim 1, wherein at least one compound of the formula II 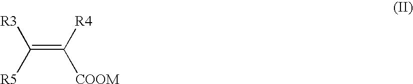
where
R3 and R4, independently of one another, may in each case be identical or different and are hydrogen or C₁-C₆-alkyl,
R5 is hydrogen, C₁-C₆-alkyl or a COOM group and
M is hydrogen, a monovalent or divalent metal ion, ammonium or an organic ammonium compound,
is used as monomer B.

4. The mineral building material composition according to claim 1, wherein the weight average molecular weight M_{w} of the polymer is from 1 000 to 100 000.

5. The mineral building material composition according to claim 1, wherein an ester of the formula III of (meth)acrylic acid with a polyalkylene oxide 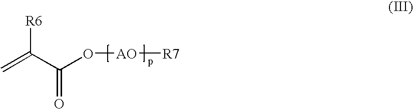
where
R6 is hydrogen or a methyl radical,
AO is C₁-C₁₂-alkylene oxide, styrene oxide or a mixture of two or more types thereof, the two or more types being linked either in random or in block form,
R7 is hydrogen, C₁-C₃₀-alkyl, C₅-C₈-cycloalkyl, C₆-C₂₀-aryl, C₁-C₃₀-alkanoyl or C₇-C₂₁-aroyl and
p is an integer from 1 to 300,
is used as monomer C.

6. A cement dispersant comprising the mineral building material composition of claim 1.

7. A gypsum dispersant comprising the mineral building material composition of claim 1.

8. A polymer obtainable by polymerizing
a) at least one alkoxylated derivative of 3-allyloxy-1,2-propanediol (monomer A) and
b) at least one ethylenically unsaturated mono- or dicarboxylic acid or the anhydrides, esters or mixtures thereof (monomer B) and
c) if appropriate, one or more further ethylenically unsaturated monomers C.

9. The polymer according to claim 8, wherein at least one monomer C selected from the esters of (meth)acrylic acid with a polyalkylene oxide of the formula III 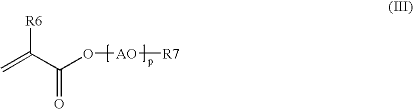
where
R6 is hydrogen or a methyl radical,
AO is C₁-C₁₂-alkylene oxide, styrene oxide or a mixture of two or more types thereof, it being possible for the two or more types to be linked either in random or in block form,
R7 is hydrogen, C₁-C₃₀-alkyl, C₅-C₈-cycloalkyl, C₆-C₂₀-aryl, C₁-C₃₀-alkanoyl or C₇-C₂₁-aroyl and
p is an integer from 1 to 300,
is used.

10. The polymer according to claim 8, wherein at least one compound of the formula I 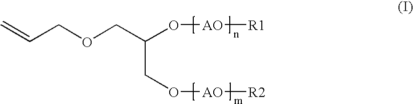
where
AO is C₁-C₁₂-alkylene oxide, styrene oxide or a mixture of two or more types thereof, it being possible for the two or more types to be linked either in random or in block form,
n and m, independently of one another, are each an integer from 1 to 300 and
R1 and R2, independently of one another, are each hydrogen, C₁-C₃₀-alkyl, C₅-C₈-cycloalkyl, C₆-C₂₀-aryl, C₁-C₃₀-alkanoyl, C₇-C₂₁-aroyl, sulfuric (mono)ester or phosphoric ester,
is used as monomer A.

11. The polymer according to claim 8, wherein at least one compound of the formula II 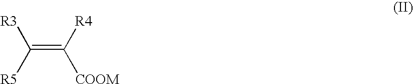
where
R3 and R4, independently of one another, may in each case be identical or different and are hydrogen or C₁-C₆-alkyl,
R5 is hydrogen, C₁-C₆-alkyl or a COOM group and
M is hydrogen, a monovalent or divalent metal ion, ammonium or an organic ammonium compound,
is used as monomer B.

12. A cement dispersant comprising at least one polymer according to claim 8.

13. A gypsum dispersant comprising at least one polymer according to claim 8.

14. A mineral building material comprising cement, water and at least one polymer according claim 8 and further conventional aggregates.

15. A mineral building material comprising gypsum, water and at least one polymer according to claim 8 and further conventional aggregates.
